(19) United States
(12) Patent Application Publication
(10) Pub. No.: US 2022/0348193 A1
(43) Pub. Date: Nov. 3, 2022

(54) Active Driving Intervention Sytem and Method Based on Acceleration Rate Optimization

(71) Applicant: CHANG'AN UNIVERSITY, Shaanxi (CN)

(72) Inventors: Hui HU, Shaanxi (CN); Mengyuan LIU, Shaanxi (CN); Guangyuan YANG, Shaanxi (CN); Yanhui WANG, Xi'an (CN); Zhiyu FENG, Shaanxi (CN); Yuqin WANG, Shaanxi (CN)

(73) Assignee: CHANG'AN UNIVERSITY, Shaanxi (CN)

(21) Appl. No.: 17/760,579

(22) PCT Filed: Mar. 29, 2021
(86) PCT No.: PCT/CN2021/083487

§ 371 Date: Mar. 15, 2022

(30) Foreign Application Priority Data
Mar. 31, 2020 (CN) 202010245665.4

(51) Int. Cl. B60W 30/09; B60W 10/04; B60W 10/18; B60W 40/107

(52) U.S. Cl. CPC B60W 30/09; B60W 10/04; B60W 10/18; B60W 40/107; B60W 2520/105; B60W 2554/802; B60W 2554/4041; B60W 2554/4045; B60W 2420/52

(57) ABSTRACT

An active driving intervention system and method based on acceleration rate optimization. After acquiring a distance from a vehicle ahead and a velocity of a driving vehicle, an evenly varying optimal acceleration variation when the driving vehicle is rapidly accelerated or rapidly decelerated in a safe condition may be calculated, which can be used to assist an accelerator or a brake in active intervention of a vehicle acceleration and appropriate adjustment of the opening of an accelerator or brake pedal, thereby realizing active intervention on driving operation. The method and system of the present disclosure can achieve the purpose of reducing energy consumption.

### CROSS REFERENCE TO RELATED APPLICATION

This patent application is a national stage entry filing under 35 USC 371 to PCT/CN2021/083487 filed Mar. 29, 2021 and which claims the benefit and priority of Chinese Patent Application No. 202010245665.4 filed on Mar. 31, 2020 and entitled “ACTIVE DRIVING INTERVENTION SYSTEM AND METHOD BASED ON ACCELERATION RATE OPTIMIZATION”, the disclosure of which is incorporated by reference herein in its entirety as part of the present application.

### TECHNICAL FIELD

The present disclosure belongs to the technical field of vehicle energy saving, and in particular, relates to an active driving intervention system and method based on acceleration rate optimization.

### BACKGROUND ART

Studies have shown that under good vehicle and road conditions, a driver's driving behaviors will affect fuel consumption, and improper driving behaviors are very important factors leading to high fuel consumption. Improper driving behaviors are mainly reflected in the following two situations: first, in case of traffic congestion, a vehicle cannot maintain a safe distance from a vehicle ahead, and emergency deceleration is used in emergency; second, in general traffic conditions, the driving behavior of acceleration is mostly rapid acceleration, and abrupt acceleration and deceleration are important factors that lead to high fuel consumption of a vehicle.

Abrupt acceleration and deceleration will affect the increase in vehicle fuel consumption and will wear parts such as tires, engines and brake systems, thus shortening the service life and reducing the safety. Existing researches, mostly on acceleration controllers, focus on adjustment of velocities to match gear shifting or optimization of ignition devices to improve the combustion efficiency during acceleration and achieve the purpose of energy saving, without considering the fuel consumption in safety state and that caused by wrong driving behaviors.

To sum up, there is an urgent need for a new active driving intervention system and method based on acceleration rate optimization.

### SUMMARY

An objective of the present disclosure is to provide an active driving intervention system and method based on acceleration rate optimization to solve one or more technical problems in the prior art. The method of the present disclosure can avoid an excess of fuel consumption caused by abrupt acceleration and abrupt deceleration of bad driving behaviors and can realize adjustment of abrupt acceleration and deceleration with uniform acceleration changes.

To achieve the objective of the present disclosure, the following technical solutions are adopted.

The present disclosure provides an active driving intervention system based on acceleration rate optimization, including:

a vehicle-mounted system including a vehicle-mounted data acquisition module, a vehicle-mounted data processing module and a vehicle-mounted central control module that are connected to one another by means of data signal wires, where the vehicle-mounted data acquisition module is configured to acquire vehicle parameters, a distance between vehicles, a driving velocity, driving time and weather information; the vehicle-mounted data processing module includes a data storage unit, a data processing and calculating unit and a communication unit and is configured to calculate an optimal acceleration variation;

a millimeter-wave radar configured to monitor a distance between a driving vehicle and a vehicle ahead and transmit data to the vehicle-mounted data acquisition module of the vehicle-mounted system; and

an accelerator and brake control system including an auxiliary accelerator system and an auxiliary braking system and configured to receive an adjusting signal transmitted by the vehicle-mounted central control module of the vehicle-mounted system to control angles of accelerator and brake pedals, thereby achieving active driving intervention;

where the millimeter-wave radar is connected to the vehicle-mounted system by way of a controller area network (CAN) bus, and the accelerator and brake control system is connected to the vehicle-mounted system by way of a vehicle-mounted CAN bus;

during calculation of the optimal acceleration variation, provided that an emergency braking distance of the vehicle ahead is S, a method of calculating a maximum acceleration aₘₐₓ¹ with a shortest safe distance between vehicles as an equivalent relationship in a general case or in case of abrupt acceleration/deceleration includes:

calculating the maximum acceleration aₘₐₓ¹ in two vehicle driving cases according to a relationship

$${a}_{i}^{1} = \frac{{dV}_{i}^{1} ( t )}{{dt}_{i}}$$

between an acceleration and a velocity of the driving vehicle:

in a general case, a condition of keeping a safe distance L+S from the vehicle ahead being:

|∫ᵢⁱ⁺¹V¹(t)dt−∫ᵢⁱ⁺¹V²(t)dt|=L+S,

in case of abrupt acceleration and abrupt deceleration, a condition of keeping a minimum safe distance L+S from the vehicle ahead being:

Lᵢ+|∫ᵢ^{i+Δi}[V²(t)−V¹(t)]dt|=L+S,

where L is a safe distance between vehicles;

the emergency braking distance S is a distance that the vehicle ahead travels from emergency braking with a velocity V²(t) at current time t to the velocity of 0; V²(t) is the velocity of the vehicle ahead at time t, and Lᵢ is a distance between the driving vehicle and the vehicle ahead at time i;

solving the equations |∫ᵢⁱ⁺¹V¹(t)dt−∫ᵢⁱ⁺¹V²(t)dt|=L+S and Lᵢ+|∫ᵢ^{i+Δi}[V²(t)−V¹(t)]dt|=L+S to obtain the maximum acceleration aₘₐₓ¹; and

obtaining a constraint for the optimal acceleration variation Δa according to the maximum acceleration aₘₐₓ¹.

As a further improvement of the present disclosure, after obtaining the maximum acceleration aₘₐₓ¹, in the process of changing the vehicle acceleration to aₘₐₓ¹, a constraint for the optimal acceleration variation Δa in Δi units is expressed as:

aₘₐₓ¹=ΔiΔa.

As a further improvement of the present disclosure, after obtaining the maximum acceleration aₘₐₓ¹, a method of obtaining the optimal acceleration variation Δa includes:

defining an initial velocity of the driving vehicle as Vᵢ¹ and a target velocity as V_{i+Δi}¹; setting unit time of interval time from the initial velocity to the target velocity as t₀, and obtaining a relationship between a velocity change and the optimal acceleration variation Δa in the interval time as:

V_{i+Δi}¹=V_{i+Δi-1}¹+ΔiΔat₀;

expressing a displacement relation that the driving vehicle meets as:

∫ᵢ^{i+Δi}V¹(t)dt=∫ᵢⁱ⁺¹Vᵢ₊₁¹(t)dt+∫ᵢ₊₁ⁱ⁺²Vᵢ₊₂¹)dt+ . . . +∫_{i+Δi-1}^{i+Δi}V_{i+Δi}¹(t)dt;

the optimal acceleration variation Δa meeting:

$$\begin{matrix}Δ a = {a}_{i + 1}^{1} - {a}_{i}^{1} , \\ {a}_{max}^{1} = Δ i Δ a .\end{matrix}$$

As a further improvement of the present disclosure, the vehicle-mounted system further includes:

an alarming device and a voice assistant configured to report road conditions and give a prompt on a driving behavior.

The present disclosure provides an active driving intervention method based on acceleration rate optimization, including the following steps:

step 1, collecting various vehicle driving parameters by means of a vehicle-mounted data acquisition module of a vehicle-mounted system, and transmitting data to a vehicle-mounted data processing module through a data signal wire; transmitting, via a data processing and calculating unit of the vehicle-mounted data acquisition module, the data to a data storage module for compression, where an optimal acceleration variation is calculated by the data processing and calculating unit; and obtaining an adjusting pedal opening for active intervention of an accelerator and brake control system according to the optimal acceleration variation; and

step 2, transmitting an adjusting electrical signal to the accelerator and brake control system by a vehicle-mounted central control module to achieve active driving intervention;

where obtaining the optimal acceleration variation in step 1 includes the following steps: obtaining distances Lᵢ₋₁, Lᵢ between a driving vehicle and a vehicle ahead in two adjacent periods, and specifying a safe distance between vehicles as L; determining whether each of Lᵢ₋₁ and Lᵢ is greater than L, and if yes, performing no intervention; otherwise, skipping to step (1);

(1) calculating a velocity of the vehicle ahead and an acceleration of the driving vehicle, which specifically includes: measuring time ΔTᵢ, reading a current driving velocity Vᵢ¹ on an instrument panel, and obtaining a relative velocity ΔVᵢ of the two vehicles that is expressed as:

$${ΔV}_{i} = \frac{{L}_{i} - {L}_{i - 1}}{Δ {T}_{i}} ;$$

obtaining a driving velocity Vᵢ² of the vehicle ahead, which is expressed as:

Vᵢ²=Vᵢ¹ΔVᵢ;

expressing the acceleration of the driving vehicle as:

$${a}_{i}^{1} = \frac{{dV}_{i}^{1} ( t )}{{dt}_{i}} ;$$

(2) calculating a braking distance of the vehicle ahead in emergency braking, where given a deceleration of 4 m/s² in emergency braking of the vehicle ahead, time taken from starting deceleration to stop is defined as T₀, which is expressed as

$${T}_{0} = \frac{{V}_{i}^{1}}{4} ;$$

and

the braking distance is expressed as S=Vᵢ²T₀−2T₀²;

(3) calculating a maximum acceleration aₘₐₓ¹ of the driving vehicle in two cases on the premise of emergency braking of the vehicle ahead, which specifically includes:

in a general case, deriving a goal expression of a minimum safe distance L+S between vehicles with respect to velocity V as:

|∫ᵢ₊₁V¹(t)dt−∫ᵢⁱ⁺¹V²(t)dt|=L+S;

in case of abrupt acceleration and abrupt deceleration, a condition of keeping a minimum safe distance L+S from the vehicle ahead being:

Lᵢ+|∫ᵢ^{i+Δi}[V²(t)−V¹(t)]dt|=L+S;

solving the equations to obtain the maximum acceleration aₘₐₓ¹; and

obtaining a constraint for the optimal acceleration variation Δa according to the maximum acceleration aₘₐₓ¹.

As a further improvement of the present disclosure, after obtaining the maximum acceleration aₘₐₓ¹, in the process of changing the vehicle acceleration to aₘₐₓ¹, a constraint for the optimal acceleration variation Δa in Δi units is expressed as:

aₘₐₓ¹=ΔiΔa.

As a further improvement of the present disclosure, after obtaining the maximum acceleration aₘₐₓ¹, a method of obtaining the optimal acceleration variation Δa includes:

defining an initial velocity of the driving vehicle as Vᵢ¹ and a target velocity as V_{i+Δi}¹; setting unit time of interval time from the initial velocity to the target velocity as t₀, and obtaining a relationship between a velocity change and the optimal acceleration variation Δa in the interval time as:

V_{i+Δ1}¹=V_{i+Δi-1}¹+αiΔat₀;

expressing a displacement relation that the driving vehicle meets as:

∫ᵢ^{i+Δi}V¹(t)dt=∫ᵢⁱ⁺¹Vᵢ₊₁¹(t)dt+∫ᵢ₊₁ⁱ⁺²Vᵢ₊₂¹)(t)dt+ . . . +∫_{i+Δi-1}^{i+Δi}V_{i+Δi}¹(t)dt;

the optimal acceleration variation Δa meeting:

$$\begin{matrix}Δ a = {a}_{i + 1}^{1} - {a}_{i}^{1} , \\ {a}_{max}^{1} = Δ i Δ a .\end{matrix}$$

As a further improvement of the present disclosure, the method further includes:

step 3, calculating a dynamic driving velocity of the driving vehicle with the variation Δa and a vehicle driving trajectory, which are expressed as:

$$\begin{matrix}{V}_{i + 1}^{1} = {V}_{i}^{1} + \frac{d Δ a}{d Δ t} ; \\ {a}_{i + 1}^{1} = {a}_{i}^{1} + Δ a ; \\ {V}_{i + 1}^{1} = {V}_{i}^{1} + {a}_{i + 1}^{1} {t}_{i} ; \\ {X}_{i + 1} = {X}_{i} + {V}_{i}^{1} {t}_{i} + 0.5 {a}_{i + 1}^{1} {t}_{i}^{2} ;\end{matrix}$$

where Xᵢ is a displacement of the vehicle at time i.

Compared with the prior art, the present disclosure has the following beneficial effects:

1. By collecting data on the current driving situation of a vehicle, the present disclosure permits real-time monitoring of the driving states of the driving vehicle and a vehicle ahead and dynamic adjustment of the opening of a vehicle accelerator or brake to limit a vehicle velocity, thereby minimizing traffic accidents to achieve the purpose of safety.

2. With the method of the present disclosure, in a general case and in case of abrupt acceleration/deceleration, it is possible to accurately calculate the optimal acceleration rate of a vehicle in a safe condition and to adjust the accelerator or brake pedal slowly and uniformly for the purpose of vehicle energy saving.

3. The present disclose has the characteristics of safety, energy saving, and environmental protection, and can be extended to various types of vehicles with minor changes to vehicles. This method can be added to a vehicle-mounted system for intelligent control, and has market value and broad application prospects.

### BRIEF DESCRIPTION OF THE DRAWINGS

The present disclosure will be further described below with reference to the accompanying drawings.

FIG. 1 is a connection diagram of an active driving intervention system based on acceleration rate optimization according to an embodiment of the present disclosure.

FIG. 2 is a structure diagram of an active driving intervention system based on acceleration rate optimization according to an embodiment of the present disclosure.

FIG. 3 is a flowchart of an active driving intervention system based on acceleration rate optimization according to an embodiment of the present disclosure.

FIG. 4 is a diagram showing a deceleration V-t relationship in an embodiment of the present disclosure.

### DETAILED DESCRIPTION OF THE EMBODIMENTS

To make the objectives, technical solutions and advantages of embodiments of the present disclosure clearer, the technical solutions in the embodiments of the present disclosure will be described below clearly and completely in conjunction with the accompanying drawings in the embodiments of the present disclosure. Obviously, the described embodiments are some, rather than all of the embodiments. Other embodiments derived from the embodiments of the present disclosure by a person of ordinary skill in the art without creative of efforts shall all fall within the protection scope of the present disclosure.

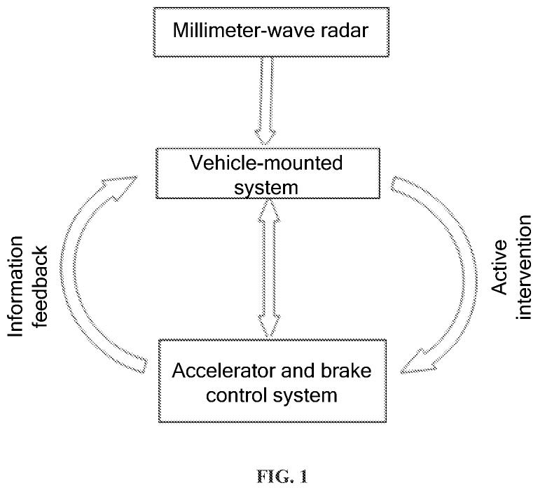

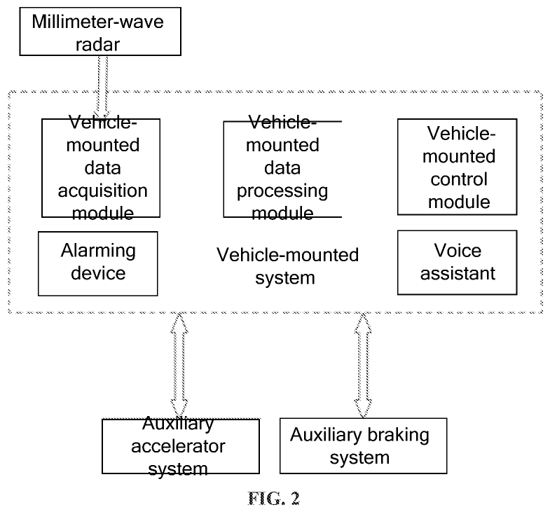

Referring to FIG. 1 and FIG. 2, an embodiment of the present disclosure provides an active driving intervention system based on acceleration rate optimization, including a vehicle-mounted system, a millimeter-wave radar, and an accelerator and brake control system, where the millimeter-wave radar is connected to the vehicle-mounted system by way of a CAN bus; and the accelerator and brake control system is connected to the vehicle-mounted system by way of a vehicle-mounted CAN bus for exchanging and feeding back data.

The vehicle-mounted system includes a vehicle-mounted data acquisition module, a vehicle-mounted data processing module, a vehicle-mounted central control module, an alarming device and a voice assistant. Different modules are connected to one another by means of data signal wires.

The vehicle-mounted data acquisition module is configured to acquire data such as vehicle parameters, a distance between vehicles, a driving velocity, driving time and weather information.

The vehicle-mounted data processing module includes a data storage unit, a data processing and calculating unit and a communication unit and is mainly configured to calculate an optimal acceleration variation.

The vehicle-mounted central control module is configured to transmit data from the vehicle-mounted data processing module to the accelerator and brake control system by way of the CAN bus and give an adjusting signal, and the voice assistant gives a prompt that the vehicle needs assisted intervention to a driver.

The millimeter-wave radar is configured to monitor a distance between a driving vehicle and a vehicle ahead and transmit data to the vehicle-mounted data acquisition module of the vehicle-mounted system.

The accelerator and brake control system includes an auxiliary accelerator system and an auxiliary braking system and is configured to perform active intervention on the vehicle. Specifically, the vehicle-mounted system transmits an adjusting signal to the accelerator and brake control system to control angles of accelerator and brake pedals, thereby achieving the purpose of reducing fuel consumption.

The voice assistant and the alarming device are configured to report road conditions in real time and give a prompt on a driving behavior to a driver.

In the system of the embodiment of the present disclosure, a method of adjusting an optimal acceleration is as follows:

1. By acquiring two adjacent distances Lᵢ₋₁, Lᵢ between vehicles, a safe distance L and time ΔTᵢ and reading a current driving velocity Vᵢ¹ on an instrument panel, a relative velocity ΔVᵢ of two vehicles, a driving velocity Vᵢ²of a vehicle ahead and an acceleration aᵢ¹ of the driving vehicle may be obtained.

2. An emergency braking distance S of the vehicle ahead in abrupt deceleration is calculated.

3. A maximum acceleration aₘₐₓ¹ of the driving vehicle in two cases on the premise of emergency braking of the vehicle ahead is calculated, and goal expressions of distances between vehicles with respect to velocity V in a general case and in case of abrupt acceleration/deceleration are as follow:

|∫ᵢⁱ⁺¹V¹(t)dt−∫ᵢⁱ⁺¹V²(t)dt|=L;

Lᵢ+∫ᵢⁱ⁺ⁱ[V²(t)−V¹(t)]dt=L;

4. The optimal acceleration variation Δa maintained in unit time when the vehicle reaches a potentially maximum acceleration aₘₐₓ¹ is calculated, and the following conditions are met:

Δa=aᵢ₊₁¹−aᵢ¹,

aₘₐₓ¹=ΔiΔa,

To sum up, the equations are solved to obtain the optimal acceleration variation Δa. Based on the optimal acceleration variation Δa, a driver can carry out active drying intervention by using the system of the present invention during abrupt acceleration or deceleration. That is to say, the included angularity β is changed per unit time t₀ in the same direction according to the V-t curve, and the maximum acceleration aₘₐₓ¹ is achieved slowly and uniformly with the variation Δa, thus achieving the purpose of saving fuel.

5. A driving trajectory of the driving vehicle is predicted.

$$\{ \begin{matrix}{a}_{i + 1}^{1} = {a}_{i}^{1} + Δ a \\ {V}_{i + 1}^{1} = {V}_{i}^{1} + {a}_{i + 1}^{1} {t}_{i} \\ {X}_{i + 1} = {X}_{i} + {V}_{i}^{1} {t}_{1} + 0.5 {a}_{i + 1}^{1} {t}_{i}^{2}\end{matrix}$$

where Xᵢ is a displacement of the vehicle at time i, which is displayed on a vehicle-mounted display screen.

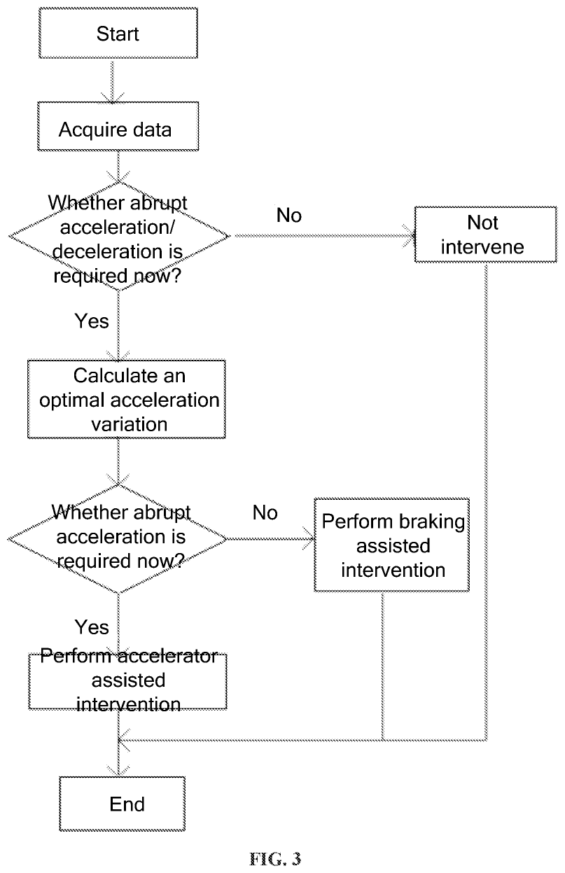

Referring to FIG. 3, the present disclosure provides an active driving intervention method based on acceleration rate optimization, including the following steps:

step 1, collect various vehicle driving parameters by means of a vehicle-mounted data acquisition module, and transmit data to a vehicle-mounted data processing module through a data signal wire; transmit, via a data processing and calculating unit, the data to a data storage module for compression; obtain an optimal acceleration variation, and calculating an adjusting pedal opening for active intervention of an accelerator and brake control system; and

step 2, transmit the compressed data to a vehicle-mounted central control module via a communication module, and transmit an adjusting electrical signal to the accelerator and brake control system by the vehicle-mounted central control module through a communication unit, and display a predicted driving trajectory on a vehicle-mounted display screen.

In the embodiment of the present disclosure, obtaining the optimal acceleration variation in step 1 includes the following steps:

obtain two adjacent distances Lᵢ₋₁, Lᵢ from a vehicle ahead, and specify a safe distance between vehicles as L;

determine whether each of Lᵢ₋₁ and Lᵢ is greater than L, and if yes, perform no intervention;

otherwise, perform the following steps. The specific steps are as follows:

(1) A velocity of the vehicle ahead and an acceleration of the driving vehicle are calculated.

Meanwhile, by measuring time ΔTᵢ and reading a current driving velocity Vᵢ¹ on an instrument panel, a relative velocity ΔVᵢ of the two vehicles may be derived as:

$$Δ {V}_{i} = \frac{{L}_{i} - {L}_{i - 1}}{Δ {T}_{i}} ; \qquad ( 1 )$$

a driving velocity of the vehicle ahead may be derived as Vᵢ²:

Vᵢ²=Vᵢ¹+ΔVᵢ; (2)

and the acceleration of the driving vehicle may be derived as:

$${a}_{i}^{1} = \frac{{dV}_{i}^{1} ( t )}{{dt}_{i}} . \qquad ( 3 )$$

(2) A braking distance of the vehicle ahead in emergency braking is calculated.

In order to prevent the danger caused by the emergency braking of the vehicle ahead, the braking distance S of the emergency braking of the vehicle ahead needs to be considered. In terms of the braking ability of a vehicle, the maximum deceleration of the vehicle during emergency braking is generally 7.5 to 8 m/s². During ordinary braking, an average deceleration of a vehicle should be 3 to 4 m/s². But in actual use of braking, except for emergencies, the braking deceleration should generally not be greater than 1.5 to 2.5 m/s², otherwise it will not only make passengers feel uncomfortable or cause danger or render goods unsafe but also increase fuel consumption and tire wear.

In this study, it is contemplated that a deceleration of the vehicle ahead in emergency braking in a general driving case is 4 m/s², and time taken from starting deceleration to stop is T₀:

$${T}_{0} = \frac{{V}_{i}^{1}}{4} \qquad ( 4 )$$

$$S = {V}_{i}^{2} {T}_{0} - 2 {T}_{0}^{2} . \qquad ( 5 )$$

(3) A maximum acceleration aₘₐₓ¹ of the driving vehicle in two cases on the premise of emergency braking of the vehicle ahead is calculated.

In a general case, a goal expression of a minimum safe distance L+S between vehicles with respect to velocity V is derived as:

|∫ᵢⁱ⁺¹V¹(t)dt−∫ᵢⁱ⁺¹V²(t)dt|=L+S; (6)

in case of abrupt acceleration or abrupt deceleration, a condition of keeping a minimum safe distance L+S from the vehicle ahead is as follows:

L+|∫ᵢ^{i+Δ1}[V²(t)−V¹(t)]dt|=L+S. 7)

where L is a safe distance between vehicles specified based on vehicle types, vehicle velocities and weather in the “Regulations for the Implementation of the Law of the People's Republic of China on Road Traffic Safety”;

the emergency braking distance S is a distance that the vehicle ahead travels from emergency braking with a velocity V²(t) at current time t to the velocity of 0; V²(t) is the velocity of the vehicle ahead at time t, and Lᵢ is a distance between the driving vehicle and the vehicle ahead at time i.

The above equations are solved to obtain the maximum acceleration aₘₐₓ¹.

(4) The optimal acceleration variation Δa maintained in unit time when the vehicle reaches a potentially maximum acceleration aₘₐₓ¹ is calculated.

By defining an initial velocity of the vehicle as Vᵢ¹ and a target velocity as V_{i+Δi}¹ and setting unit time of interval time from the initial velocity to the target velocity as t₀, a relationship between a velocity change and the optimal acceleration variation Δa in the interval time is derived as:

$$\begin{matrix}{V}_{i + 1}^{1} = {V}_{i}^{1} + Δ {at}_{0} \\ {V}_{i + 2}^{1} = {V}_{i + 1}^{1} + 2 Δ {at}_{0} \\ {V}_{i + 3}^{1} = {V}_{i + 2}^{1} + 3 Δ {at}_{0} \\ … \\ {V}_{i + Δ i}^{1} = {V}_{i + Δ i - 1}^{1} + Δ i Δ {at}_{0}\end{matrix} \qquad ( 8 )$$

The vehicle meets the following displacement relation:

∫ᵢⁱ⁺¹V¹(t)dt=∫ᵢⁱ⁺¹Vᵢ₊₁¹(t)dt+∫hd i+1ⁱ⁺²Vᵢ₊₂¹(t)dt+ . . . +∫_{i+Δi}^{i+Δi}V_{i+Δi}¹(t)dt (9)

The optimal acceleration variation Δa meets:

$$Δ a = {a}_{i + 1}^{1} - {a}_{i}^{1} \qquad ( 10 )$$

$${a}_{max}^{1} = Δ i Δ a \qquad ( 11 )$$

The above equations are combined and solved to obtain the optimal acceleration variation Δa.

(5) A dynamic driving velocity of the vehicle with the variation AΔa and a vehicle driving trajectory are calculated as:

$${V}_{i + 1}^{1} = {V}_{i}^{1} + \frac{d Δ a}{d Δ t} \qquad ( 12 )$$

A driving trajectory of the driving vehicle is predicted based on the calculated dynamic driving velocity of the vehicle with the variation Δa:

$$\{ \begin{matrix}{a}_{i + 1}^{1} = {a}_{i}^{1} + Δ a \\ {V}_{i + 1}^{1} = {V}_{i}^{1} + {a}_{i + 1}^{1} {t}_{i} \\ {X}_{i + 1} = {X}_{i} + {V}_{i}^{1} {t}_{i} + 0.5 {a}_{i + 1}^{1} {t}_{i}^{2}\end{matrix} \qquad ( 13 )$$

where Xᵢ is a displacement of the vehicle at time i.

The method further includes step 3: transmit algorithm result Δa in the active intervention method and the vehicle velocity Vᵢ₊₁¹ with the variation to a vehicle-mounted control module which further transmits the received data to the accelerator and brake control system through a CAN bus, and correspondingly change the opening of the accelerator pedal or the brake pedal to achieve active intervention.

Among numerous driving accelerations, abrupt acceleration and abrupt deceleration will cause extremely high fuel consumption and will result in insufficient fuel burning and reduced combustion efficiency. Abrupt acceleration/deceleration will not only affect vehicle fuel consumption but also wear parts such as tires, engines and brake systems, thus shortening the service life and reducing the safety. With the method of the present disclosure, by collecting data on the current driving situation of a vehicle, it is possible to obtain the optimal acceleration rate in case of abrupt acceleration/deceleration in a safe condition and to adjust the accelerator or brake pedal slowly and uniformly for the purpose of vehicle energy saving.

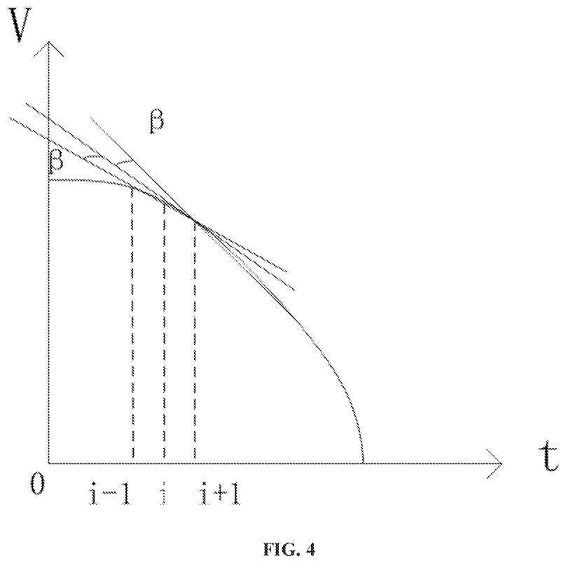

FIG. 4 is a diagram showing a deceleration V-t relationship in a calculation method for active driving intervention during goods transportation with the optimal energy consumption according to an embodiment of the present disclosure. The slope at each point of the curve shown in the figure is the acceleration of the vehicle, and β is the angularity of tangent line of the acceleration variation per unit time, which indicates the optimal acceleration variation Δa. This figure shows the optimal acceleration variation Δa calculated by uniformly adjusting the acceleration change in the process of reaching the maximum acceleration aₘₐₓ¹ during abrupt acceleration/deceleration. This figure takes deceleration for example, and it is similar for acceleration.

To sum up, in the method of the embodiment of the present disclosure, the vehicle-mounted data acquisition module of the vehicle-mounted system collects vehicle parameters, distances between vehicles, driving velocities, driving time, etc. The vehicle-mounted data processing module determines whether active intervention is required. If no, intervention is not performed. If yes, intervention is initiated, and the optimal acceleration variation is calculated. Whether abrupt acceleration adjustment is needed is then determined. If yes, the auxiliary accelerator system is started; and if no, the auxiliary braking system is started. According to the present disclosure, after acquiring a distance from a vehicle ahead and a velocity of a current vehicle, an evenly varying optimal acceleration variation when the driving vehicle is rapidly accelerated or rapidly decelerated in a safe condition may be calculated, which can be used to assist an accelerator or a brake in active intervention of a vehicle acceleration and appropriate adjustment of the opening of an accelerator or brake pedal, thereby realizing active intervention on driving operation and achieving the purpose of reducing energy consumption.

Those skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may be in a form of a computer program product that is implemented on one or more computer-usable storage media (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, such that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

The above embodiments are merely intended to describe the technical solutions of the present disclosure, rather than to limit the present disclosure. Although the present disclosure is described in detail with reference to the above embodiments, a person of ordinary skill in the art may still make modifications or equivalent substitutions to the specific embodiments of the present disclosure without departing from the spirit and scope of the present disclosure, and these modifications or equivalent substitutions shall fall within the protection scope of the claims of the present disclosure.

What is claimed is:

1. An active driving intervention system based on acceleration rate optimization, comprising:
a vehicle-mounted system comprising a vehicle-mounted data acquisition module, a vehicle-mounted data processing module and a vehicle-mounted central control module that are connected to one another by means of data signal wires, wherein the vehicle-mounted data acquisition module is configured to acquire vehicle parameters, a distance between vehicles, a driving velocity, driving time and weather information; the vehicle-mounted data processing module comprises a data storage unit, a data processing and calculating unit and a communication unit and is configured to calculate an optimal acceleration variation;
a millimeter-wave radar configured to monitor a distance between a driving vehicle and a vehicle ahead and transmit data to the vehicle-mounted data acquisition module of the vehicle-mounted system; and
an accelerator and brake control system comprising an auxiliary accelerator system and an auxiliary braking system and configured to receive an adjusting signal transmitted by the vehicle-mounted central control module of the vehicle-mounted system to control angles of accelerator and brake pedals, thereby achieving active driving intervention;
wherein the millimeter-wave radar is connected to the vehicle-mounted system by way of a controller area network (CAN) bus, and the accelerator and brake control system is connected to the vehicle-mounted system by way of a vehicle-mounted CAN bus; and
during the calculation of the optimal acceleration variation, provided that an emergency braking distance of the vehicle ahead is S, a method of calculating a maximum acceleration with a shortest safe distance between vehicles as an equivalent relationship aₘₐₓ¹ in a general case or in case of abrupt acceleration/deceleration comprises:
calculating the maximum acceleration aₘₐₓ¹ in two vehicle driving cases according to a relationship
$${a}_{i}^{1} = \frac{{dV}_{i}^{1} ( t )}{{dt}_{i}}$$
between an acceleration and a velocity of the driving vehicle:
in a general case, a condition of keeping a safe distance L+S from the vehicle ahead being:

|∫ᵢⁱ⁺¹V¹t)dt−∫ᵢⁱ⁺¹V²(t)dt|=L+S,
in case of abrupt acceleration or abrupt deceleration, a condition of keeping a safe distance L+S from the vehicle ahead being:
Lᵢ+|∫ᵢ^{i+Δi}[V²(t)−V¹(t)]dt|=L+S,
wherein L is a safe distance between vehicles;
the emergency braking distance S is a distance that the vehicle ahead travels from emergency braking with a velocity V²(t) at current time t to the velocity of 0; V²(t) is the velocity of the vehicle ahead at time t, and Lᵢ is a distance between the driving vehicle and the vehicle ahead at time i;
solving the equations |∫ᵢⁱ⁺¹V¹(t)dt−∫ᵢⁱ⁺¹V²(t) dt|=L+S and and Lᵢ+|∫ᵢ^{i+Δi}[V²(t)−V¹(t)]dt|=L+S to obtain the maximum acceleration aₘₐₓ¹; and
obtaining a constraint for the optimal acceleration variation Δa according to the maximum acceleration aₘₐₓ¹.

2. The active driving intervention system based on acceleration rate optimization according to claim 1, wherein after obtaining the maximum acceleration aₘₐₓ¹, in the process of changing the vehicle acceleration to aₘₐₓ¹, a constraint for the optimal acceleration variation Δa in Δi units is expressed as:
aₘₐₓ¹32 ΔiΔa.

3. The active driving intervention system based on acceleration rate optimization according to claim 1, wherein after obtaining the maximum acceleration aₘₐₓ¹, a method of obtaining the optimal acceleration variation Δa comprises:
defining an initial velocity of the driving vehicle as Vᵢ¹ and a target velocity as V_{i+Δi}¹;
setting unit time of interval time from the initial velocity to the target velocity as t₀, and obtaining a relationship between a velocity change and the optimal acceleration variation Δa in Δi the interval time as:
V_{i+Δi}¹=V_{i+Δi-1}¹+ΔiΔat₀;
expressing a displacement relation that the driving vehicle meets as:
∫ᵢ^{i+Δi}V¹(t)dt=∫ᵢⁱ⁺¹Vᵢ₊₁¹(t)dt+∫ᵢ₊₁ⁱ⁺²Vᵢ₊₂¹(t)dt+ . . . +∫_{i+Δi-1}^{i+Δi}V_{i+Δi}¹(t)dt; and
the optimal acceleration variation Δa meeting: Δa=aᵢ₊₁¹−aᵢ¹,
aₘₐₓ¹=ΔiΔa.

4. The active driving intervention system based on acceleration rate optimization according to claim 1, wherein the vehicle-mounted system further comprises:
an alarming device and a voice assistant configured to report road conditions and give a prompt on a driving behavior.

5. An active driving intervention method based on acceleration rate optimization, comprising the following steps:
step 1, collecting various vehicle driving parameters by means of a vehicle-mounted data acquisition module of a vehicle-mounted system, and transmitting data to a vehicle-mounted data processing module through a data signal wire; transmitting, via a data processing and calculating unit of the vehicle-mounted data acquisition module, the data to a data storage module for compression, wherein an optimal acceleration variation is calculated by the data processing and calculating unit; and obtaining an adjusting pedal opening for active intervention of an accelerator and brake control system according to the optimal acceleration variation; and
step 2, transmitting an adjusting electrical signal to the accelerator and brake control system by a vehicle-mounted central control module to achieve active driving intervention;
wherein obtaining the optimal acceleration variation in step 1 comprises the following steps:
obtaining distances Lᵢ₋₁, Lᵢ between a driving vehicle and a vehicle ahead in two adjacent periods of time, and specifying a safe distance between vehicles as L; determining whether each of Lᵢ₋₁ and Lᵢ is greater than L, and if yes, performing no intervention; otherwise, skipping to step (1);
(1) calculating a velocity of the vehicle ahead and an acceleration of the driving vehicle, which specifically comprises: measuring time ΔTᵢ, reading a current driving velocity Vᵢ¹ on an instrument panel, and obtaining a relative velocity ΔVᵢ of the two vehicles that is expressed as:
$$Δ {V}_{i} = \frac{{L}_{i} - {L}_{i - 1}}{Δ {T}_{i}} ,$$
obtaining a driving velocity Vᵢ² of the vehicle ahead, which is expressed as:
Vᵢ²Vᵢ¹+ΔVᵢ;
expressing the acceleration of the driving vehicle as:
$${a}_{i}^{1} = \frac{{dV}_{i}^{1} ( t )}{{dt}_{i}} ;$$
(2) calculating a braking distance of the vehicle ahead in emergency braking, wherein given a deceleration of 4 m/s² in emergency braking of the vehicle ahead, time taken from starting deceleration to stop is defined as T₀, which is expressed as
$${T}_{0} = \frac{{V}_{i}^{1}}{4} ;$$
and
the braking distance is expressed as S=Vᵢ²T₀−2T₀²; and
(3) calculating a maximum acceleration aₘₐₓ¹ of the driving vehicle in two cases on the premise of emergency braking of the vehicle ahead, which specifically comprises:
in a general case, deriving a goal expression of a minimum safe distance L+S between vehicles with respect to velocity V as:

|∫ᵢⁱ⁺¹V¹(t)dt−∫ᵢⁱ⁺¹V²(t)dt|=L+S.
in case of abrupt acceleration or abrupt deceleration, a condition of keeping a safe distance L+S from the vehicle ahead being:
Lᵢ+|∫ᵢ^{i+Δ1}[V²(t)−V¹(t)]dt|=L+S;
solving the equations to obtain the maximum acceleration aₘₐₓ¹ and obtaining a constraint for the optimal acceleration variation Δa according to the maximum acceleration aₘₐₓ¹.

6. The active driving intervention method based on acceleration rate optimization according to claim 5, wherein,
after obtaining the maximum acceleration aₘₐₓ¹, in the process of changing the vehicle acceleration to aₘₐₓ¹, a constraint for the optimal acceleration variation Δa in Δi units is expressed as:
aₘₐₓ¹−ΔiΔa.

7. The active driving intervention method based on acceleration rate optimization according to claim 5, wherein,
after obtaining the maximum acceleration aₘₐₓ¹, a method of obtaining the optimal acceleration variation Δa comprises:
defining an initial velocity of the driving vehicle as Vᵢ¹ and a target velocity as V_{i+Δi}¹; setting unit time of interval time from the initial velocity to the target velocity as t₀, and obtaining a relationship between a velocity change and the optimal acceleration variation Δa in the interval time as:
V_{i+Δi}¹=V_{i+Δi-1}¹+ΔiΔat₀;
expressing a displacement relation that the driving vehicle meets as:
∫ᵢ^{i+Δi}V¹(t)dt=∫ᵢⁱ⁺¹Vᵢ₊₁^{t}(t)dt+∫ᵢ₊₁¹⁺²Vᵢ₊₂¹(t)dt+ . . . +∫_{i+Δi-1}^{i+Δi}V_{i+Δ1}(t)dt;
the optimal acceleration variation Δa meeting:
$$\begin{matrix}Δ a = {a}_{i + 1}^{1} - {a}_{i}^{1} , \\ {a}_{max}^{1} = Δ i Δ a .\end{matrix}$$

8. The active driving intervention method based on acceleration rate optimization according to claim 7, further comprising:
step 3, calculating a dynamic driving velocity of the driving vehicle with the variation Δa and a vehicle driving trajectory, which are expressed as:
$$\begin{matrix}{V}_{i + 1}^{1} = {V}_{i}^{1} + \frac{d Δ a}{d Δ t} ; \\ {a}_{i + 1}^{1} = {a}_{i}^{1} + Δ a ; \\ {V}_{i + 1}^{1} = {V}_{i}^{1} + {a}_{i + 1}^{1} {t}_{i} ; \\ {X}_{i + 1} = {X}_{i} + {V}_{i}^{1} {t}_{i} + 0.5 {a}_{i + 1}^{1} {t}_{i}^{2} ;\end{matrix}$$
wherein Xᵢ is a displacement of the vehicle at time i.
